(19) United States
(12) Patent Application Publication
(10) Pub. No.: US 2023/0106603 A1
(43) Pub. Date: Apr. 6, 2023

(54) ADDITIVE MANUFACTURING APPARATUS AND ADDITIVE MANUFACTURING METHOD

(71) Applicant: Sodick Co., Ltd., Kanagawa (JP)

(72) Inventors: Mikio KANEKO, Kanagawa (JP); Katsuhiko KOBAYASHI, Kanagawa (JP); Kyokatsu MOTOYA, Kanagawa (JP)

(73) Assignee: Sodick Co., Ltd., Kanagawa (JP)

(21) Appl. No.: 17/954,329

(22) Filed: Sep. 28, 2022

(30) Foreign Application Priority Data
Oct. 4, 2021 (JP) 2021-163652

(51) Int. Cl. G06T 7/73; G06T 7/60; G06T 7/77; G06T 7/00; B33Y 10/00; B33Y 30/00; B33Y 50/00; B29C 64/386; B29C 64/153

(52) U.S. Cl. CPC G06T 7/73; G06T 7/60; G06T 7/77; G06T 7/0004; B33Y 10/00; B33Y 30/00; B33Y 50/00; B29C 64/386; B29C 64/153; G06T 2207/30144

(57) ABSTRACT

An additive manufacturing apparatus including a chamber, a manufacturing table, an imaging device, an image processing device, and a control device, in which a base plate disposed on the manufacturing table includes a first side and a second side, a first camera in the imaging device images a first region to acquire a first image and images a second region to acquire a second image, the image processing device analyzes the first and second images to acquire position information of each side, and the control device calculates a coordinate of an intersection point of the first side and the second side or an intersection point on extended lines of the first side and the second side as a point to be detected.

### CROSS-REFERENCE TO RELATED APPLICATION

This application claims the priority benefit of Japan application serial no. 2021-163652, filed on Oct. 4, 2021. The entirety of the above-mentioned patent application is hereby incorporated by reference herein and made a part of this specification.

### BACKGROUND

### Technical Field

The disclosure relates to an additive manufacturing apparatus and an additive manufacturing method.

### Description of Related Art

In the additive manufacturing of three-dimensional manufactured articles, a variety of methods are known. For example, a metal material powder is supplied to the upper surface of a base plate disposed in a manufacturing region on a manufacturing table in a chamber filled with an inert gas to form a material layer. In addition, a predetermined position in the material layer is irradiated with laser beams or electron beams using an irradiation device, thereby sintering or melting the material layer to form a solidified layer. When such formation of the material layer and the solidified layer is repeated, the solidified layers are laminated to produce a desired three-dimensional manufactured article.

The base plate is used to protect the manufacturing table and to facilitate the fixation of the solidified layer. The manufactured article after the completion of manufacturing is removed from the manufacturing table in a state of being integrated with the base plate, and the base plate is completely cut away from the manufactured article or the manufactured article is turned into a product with all or a part of the base plate left. Patent Document 1 discloses a production method for improving the shape accuracy of a three-dimensional manufactured article having a structure in which a sintered body is formed on a base plate.

### Patent Documents

[Patent Document 1] Japanese Patent No. 6564111

### SUMMARY

In order to highly accurately irradiate a predetermined position in the material layer on the base plate with laser beams or electron beams, it is necessary to accurately perceive the position of the base plate in the manufacturing region and appropriately set the coordinate system of the irradiation device. For example, in a case where any corner of the base plate in a plan view is used as a reference point in setting the coordinate system, it is necessary to perceive the position of the corner. For the detection of the position of the reference point, not only is a contact type measuring instrument such as a touch probe, a pick tester or an energization detector applicable, but a non-contact type method in which an image including the reference point is acquired with an imaging device including a CCD camera or the like and imaging processing is carried out to acquire position information is also applicable.

In the non-contact type position detection by image acquisition, as the distance between the camera and an object to be imaged becomes shorter and as the amount of information that is included in the visual field of the camera becomes larger, the detection accuracy becomes higher. However, ordinarily, the distance from the object to be imaged and the amount of information that is included in the visual field have a trade-off relationship. For example, when the base plate comes close to the camera, the range of the base plate that is included in the visual field is further suppressed, and the amount of information in the visual field decreases. Conversely, when an attempt is made to include a wider range of the base plate in the visual field, it is necessary to bring the base plate far away from the camera.

The disclosure has been made in consideration of such circumstances and provides an additive manufacturing apparatus and an additive manufacturing method that are capable of suppressing a decrease in accuracy in the position detection of a base plate.

According to the disclosure, an additive manufacturing apparatus including a chamber, a manufacturing table, a material layer formation device, an irradiation device, an imaging device, an image processing device, and a control device, in which a manufacturing region is provided on the manufacturing table, the chamber covers the manufacturing region, a base plate is disposed in the manufacturing region, the base plate includes a first side and a second side that configure an outer edge of the base plate in a plan view, the material layer formation device forms a material layer on an upper surface of the base plate by supply of a material powder, the irradiation device forms a solidified layer by irradiating the material layer with a laser beam or an electron beam, the imaging device includes a first camera provided so as to be movable in the chamber, the first camera images a first region including at least a part of the first side to acquire a first image at a position moved along the first side toward the other end point of the first side from an initial position set such that a part and one end point of the first side and a part and one end point of the second side are included in a visual field of the first camera and images a second region including at least a part of the second side to acquire a second image at a position moved along the second side toward the other end point of the second side from the initial position, the image processing device analyzes the first image to acquire position information of the first side and analyzes the second image to acquire position information of the second side, and the control device calculates a coordinate of an intersection point of the first side and the second side or an intersection point on extended lines of the first side and the second side as a point to be detected using the position information of the first side and the position information of the second side is provided.

In the additive manufacturing apparatus according to the disclosure, the first image and the second image are acquired at a position moved from the initial position where the lengths of the first side and the second side that are included in the visual field become larger using the movable first camera. As the lengths of the sides that are included in the visual field become larger, the accuracy of the position information of the sides that is acquired from the image becomes higher. Therefore, compared with a case where the position information of the first side and the second side is acquired from an image imaged at the initial position, more accurate position information can be acquired, and accordingly, it is possible to improve the accuracy of the coordinate of the point to be detected that is calculated from the position information. In addition, since the distance between the first camera and the base plate is constant while the first camera moves from the initial position, it becomes possible to include a larger amount of information in the visual field without changing the distance from an object to be imaged.

Hereinafter, a variety of embodiments of the disclosure will be exemplified. The embodiments to be described below can be combined with each other.

Preferably, the first camera images the first region at changed movement distances from the initial position to acquire a plurality of first images and images the second region at changed movement distances from the initial position to acquire a plurality of second images, and the image processing device analyzes each of the plurality of first images to acquire the position information of the first side and analyzes each of the plurality of second images to acquire the position information of the second side.

Preferably, the image processing device detects lengths of the first sides that are included in the plurality of first images and detects lengths of the second sides that are included in the plurality of second images, and the control device calculates the coordinate of the point to be detected using the position information of the first side acquired from the first image where the detected length of the first side is the largest and the position information of the second side acquired from the second image where the detected length of the second side is the largest.

Preferably, the control device calculates the coordinate of the point to be detected using a statistical processing result of the position information of the first side and the position information of the second side.

Preferably, the first camera images the first region at a position moved parallel to the first side by a predetermined distance from the initial position to acquire the first image, the predetermined distance is equal to half of a maximum length of the visual field in a direction parallel to the first side, the first camera images the second region at a position moved parallel to the second side by a predetermined distance from the initial position to acquire the second image, and the predetermined distance is equal to half of a maximum length of the visual field in a direction parallel to the second side.

Preferably, the additive manufacturing apparatus includes a camera moving device, in which, the imaging device includes a second camera fixed in the chamber, the second camera images a region including all of the manufacturing region to acquire an entire image, the image processing device analyzes the entire image to acquire position information of the base plate in the manufacturing region, the control device produces a move command of the first camera using the position information of the base plate, and the camera moving device moves the first camera according to the move command.

According to a different viewpoint of the disclosure, an additive manufacturing method including a material layer formation step, a solidification step, first and second image acquisition steps, first and second image analysis steps and a calculation step, in which, in the material layer formation step, in a chamber that covers a manufacturing region provided on a manufacturing table, a material powder is supplied to an upper surface of a base plate disposed in the manufacturing region to form a material layer, in the solidification step, the material layer is irradiated with a laser beam or an electron beam to form a solidified layer, the base plate includes a first side and a second side that configure an outer edge of the base plate in a plan view, in the first image acquisition step, using a camera provided so as to be movable in the chamber, a first region including at least a part of the first side is imaged to acquire a first image at a position moved along the first side toward the other end point of the first side from an initial position set such that a part and one end point of the first side and a part and one end point of the second side are included in a visual field of the first camera, in the second image acquisition step, using the camera, a second region including at least a part of the second side is imaged to acquire a second image at a position moved along the second side toward the other end point of the second side from the initial position, in the first image analysis step, the first image is analyzed to acquire position information of the first side, in the second image analysis step, the second image is analyzed to acquire position information of the second side, and, in the calculation step, a coordinate of an intersection point of the first side and the second side or an intersection point on extended lines of the first side and the second side is calculated as a point to be detected using the position information of the first side and the position information of the second side is provided.

### BRIEF DESCRIPTION OF THE DRAWINGS

FIG. 1 is a schematic configuration view of an additive manufacturing apparatus 100 according to a first embodiment of the disclosure.

FIG. 2 is a perspective view of a material layer formation device 3.

FIG. 3 is a perspective view of a recorder head 11 seen from above.

FIG. 4 is a perspective view of the recorder head 11 seen from below.

FIG. 5 is a schematic configuration view of an irradiation device 13.

FIG. 6 is a plan view showing a state where a base plate 81 is disposed in a manufacturing region R.

FIG. 7 is a plan view showing a state where the base plate 81 having one corner chamfered is disposed in the manufacturing region R.

FIG. 8 is another schematic configuration view of the additive manufacturing apparatus 100 and is a view showing the configuration of the additive manufacturing apparatus 100 in FIG. 1 seen from the right side.

FIG. 9 is a view showing an example of imaging regions or visual fields of an entire imaging camera 61 and a partial imaging camera 62 in the disposition of the base plate 81 in FIG. 6.

FIG. 10 is a view showing the visual field of the partial imaging camera 62 at the time of imaging a vicinity of a corner C2 of the base plate 81.

FIG. 11 is a view for describing a change in the length of each side that is included in the visual field of the partial imaging camera 62 in FIG. 10.

FIG. 12 is a view showing the visual field of the partial imaging camera 62 at the time of imaging a vicinity of a corner C4 of the base plate 81.

FIG. 13 is a view showing the visual field of the partial imaging camera 62 in the disposition of the base plate 81 in FIG. 7.

FIG. 14 is a view showing a second image that is obtained by imaging a second region V_{C2, 2} in FIG. 10.

FIG. 15 is a block diagram showing the configuration of a control device 9.

FIG. 16 is a flowchart showing the order of setting a coordinate system for manufacturing.

FIG. 17 is a view showing a method for producing a three-dimensional manufactured article using the additive manufacturing apparatus 100.

FIG. 18 is a view showing the method for producing a three-dimensional manufactured article using the additive manufacturing apparatus 100.

FIG. 19 is a view showing a visual field of a partial imaging camera 62 in a second embodiment.

FIG. 20 is a view showing the visual field of the partial imaging camera 62 in the second embodiment.

### DESCRIPTION OF THE EMBODIMENTS

Hereinafter, embodiments of the disclosure will be described with reference to the drawings. Individual characteristics to be described in the embodiments to be described below can be combined with each other. In addition, each characteristic independently forms an invention.

1. Additive Manufacturing Apparatus 100

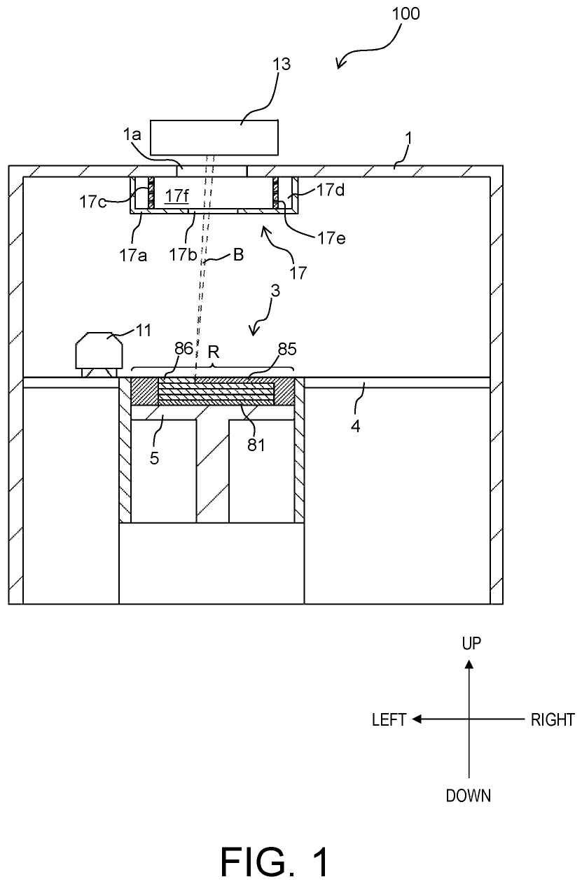

FIG. 1 is a schematic configuration view of an additive manufacturing apparatus 100 according to a first embodiment. The additive manufacturing 100 includes a chamber 1, a material layer formation device 3 and an irradiation device 13. Formation of a material layer 85 and a solidified layer 86 is repeated in a manufacturing region R provided on a manufacturing table 5 that is disposed in the chamber 1, thereby forming a desired three-dimensional manufactured article. In the following description, a direction toward the front of FIG. 1 is defined as “front” of the additive manufacturing apparatus 100, and a direction toward the back of FIG. 1 is defined as “back” of the additive manufacturing apparatus 100. In addition, the up and down direction in FIG. 1 is defined as the up and down direction (vertical direction) of the additive manufacturing apparatus 100, and the right and left direction in FIG. 1 is defined as the right and left direction of the additive manufacturing apparatus 100.

1.1. Chamber 1

The chamber 1 covers the manufacturing region R that is a region where a three-dimensional manufactured article is formed. The inside of the chamber 1 is filled with a predetermined concentration of an inert gas that is supplied from an inert gas supply device (not shown). In the present specification, the inert gas is a gas that does not substantially react with the material layer 85 or the solidified layer 86 and is selected depending on the kinds of materials, and, for example, a nitrogen gas, an argon gas and a helium gas can be used. The inert gas including a fume that is generated at the time of forming the solidified layer 86 is discharged from the chamber 1, supplied to the chamber 1 after removing the fume in a fume collector and reused. The fume collector is, for example, an electric dust collector or a filter.

A window 1a, which serves as a transmissive window of a laser beam B, is provided on the upper surface of the chamber 1. The window 1a is formed of a material capable of transmitting the laser beam B. Specifically, the material of the window 1a is selected from silica glass, borosilicate glass, the crystal of germanium, silicon, zinc selenium or potassium bromide and the like depending on the type of the laser beam B. For example, in a case where the laser beam B is a fiber laser or a YAG laser, the window 1a can be formed of silica glass.

In addition, a contamination prevention device 17 is provided on the upper surface of the chamber 1 so as to cover the window 1a. The contamination prevention device 17 includes a cylindrical housing 17a and a cylindrical diffusion member 17c disposed in the housing 17a. An inert gas supply space 17d is provided between the housing 17a and the diffusion member 17c. In addition, an opening part 17b is provided inside the diffusion member 17c in the bottom surface of the housing 17a. A number of pores 17e are provided in the diffusion member 17c, and a clear inert gas supplied to the inert gas supply space 17d is sent through the pores 17e to fill a clean room 17f. In addition, the clean inert gas used to fill the clean room 17f is blasted toward below the contamination prevention device 17 through the opening part 17b. Such a configuration makes it possible to prevent fumes from adhering to the window 1a and to exclude fumes from the irradiation path of the laser beam B.

1.2. Material Layer Formation Device 3

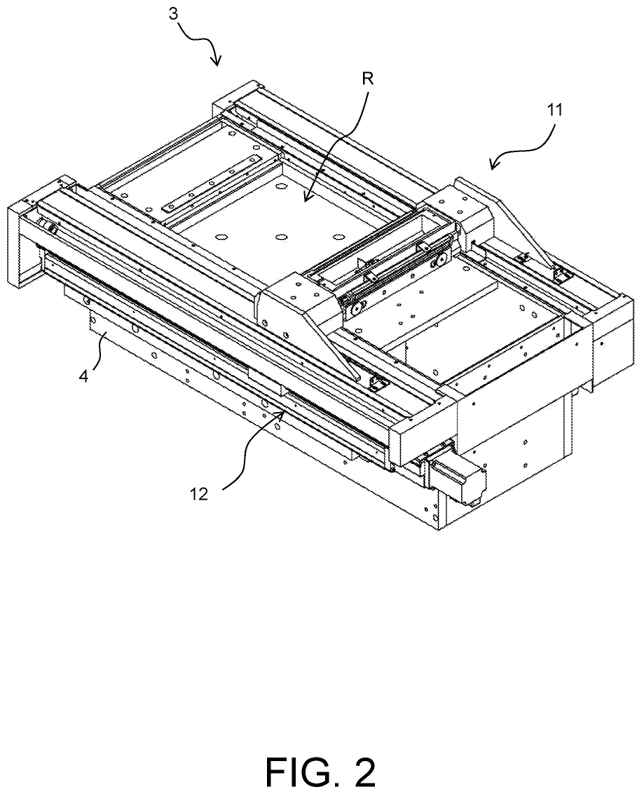

The material layer formation device 3 is provided inside the chamber 1. As shown in FIG. 2, the material layer formation device 3 includes a base 4 and a recorder head 11 that is disposed on the base 4. The recorder head 11 is configured so as to be capable of reciprocally moving in one horizontal direction with a recorder head driving device 12.

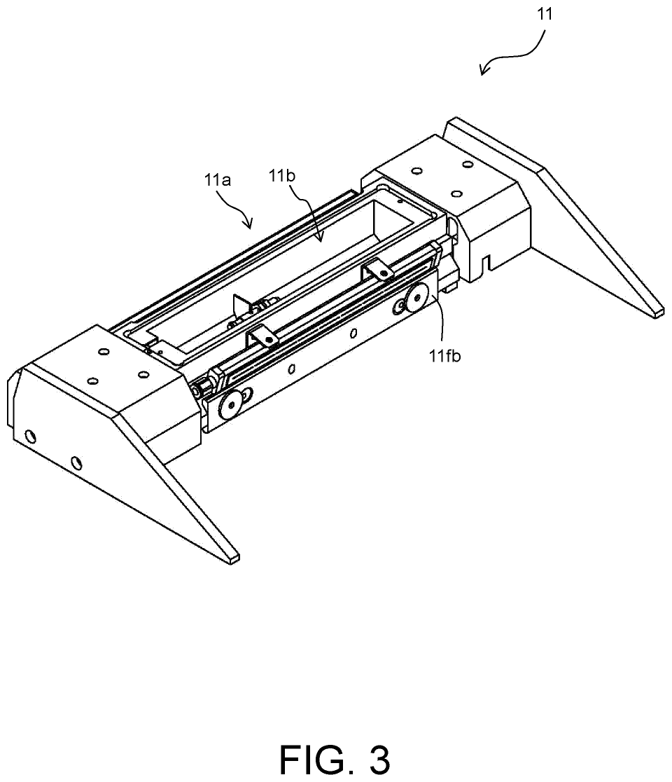

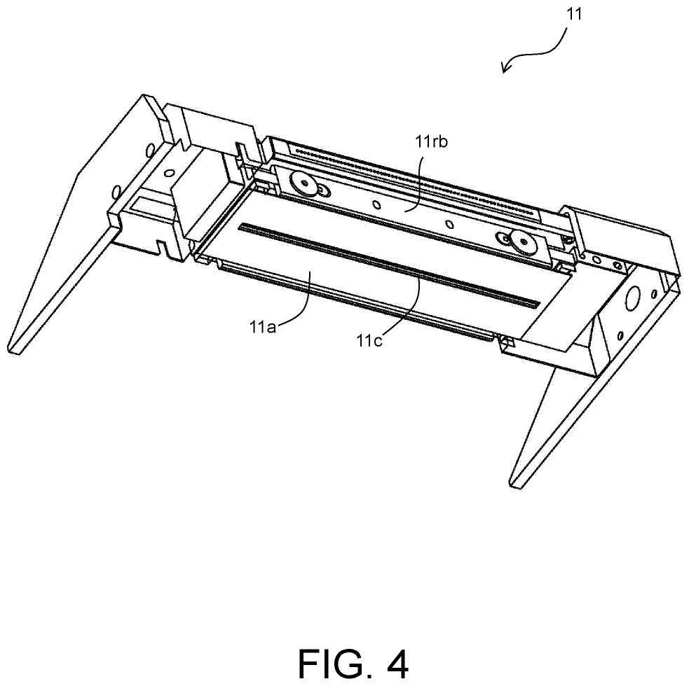

As shown in FIG. 3 and FIG. 4, the recorder head 11 includes a material accommodation part 11a, a material supply opening 11b and a material discharge opening 11c. The material supply opening 11b is provided in the upper surface of the material accommodation part 11a and serves as a reception opening of a material powder that is supplied to the material accommodation part 11a from a material supply unit (not shown). The material discharge opening 11c is provided in the bottom surface of the material accommodation part 11a and discharges the material powder in the material accommodation part 11a. The material discharge opening 11c has a slit shape extending in the longitudinal direction of the material accommodation part 11a. Flat plate-like blades 11fb and 11rb are provided on both side surfaces of the recorder head 11. The blades 11fb and 11rb flatten the material powder that is discharged from the material discharge opening 11c to form the material layer 85.

As shown in FIG. 1 and FIG. 2, the manufacturing region R is positioned on the manufacturing table 5, and a desired three-dimensional manufactured article is formed in the manufacturing region R. The manufacturing table 5 is driven with a manufacturing table driving device and is movable in the vertical direction. During manufacturing, the base plate 81 is disposed in the manufacturing region R, the material powder is supplied to the upper surface of the base plate 81, and the material layer 85 is formed.

1.3. Irradiation Device 13

As shown in FIG. 1, the irradiation device 13 is provided above the chamber 1. The irradiation device 13 irradiates an irradiation region in the material layer 85 that is formed in the manufacturing region R with the laser beam B to solidify the material powder by melting or sintering, thereby forming the solidified layer 86.

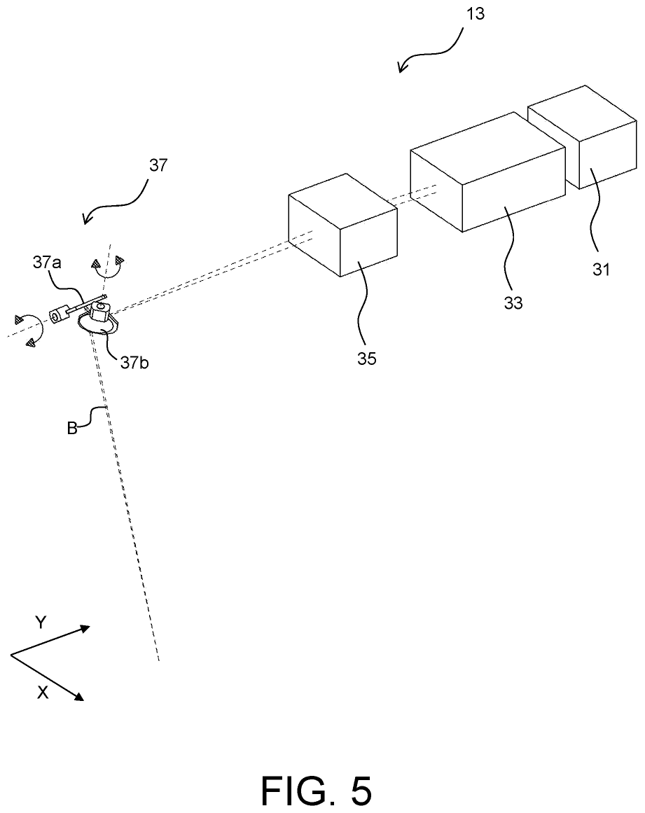

As shown in FIG. 5, the irradiation device 13 includes a light source 31, a collimator 33, a focus control unit 35 and a scanning device 37 and is controlled with an irradiation control part 96 to be described below. The light source 31 generates the laser beam B. The laser beam B needs to be capable of sintering or melting the material powder and is, for example, a fiber laser, a CO₂ laser or a YAG laser. In the present embodiment, as the laser beam B, a fiber laser is used.

The collimator 33 includes a collimator lens and converts the laser beam B output from the light source 31 to parallel light. The focus control unit 35 includes a focus control lens and a motor that moves the focus control lens forward and backward along an optical axis direction and adjusts the beam diameter of the laser beam B on the surface of the material layer 85 by adjusting the focal position of the laser beam B converted to parallel light with the collimator 33.

The scanning device 37 is, for example, a galvano scanner and includes a first galvano mirror 37a, a second galvano mirror 37b, a first actuator and a second actuator that rotate the first galvano mirror 37a and the second galvano mirror 37b to desired angles. The laser beam B that has passed through the focus control unit 35 is two-dimensionally scanned on the upper surface of the material layer 85 in the manufacturing region R with the first galvano mirror 37a and the second galvano mirror 37b. Specifically, the laser beam B is reflected by the first galvano mirror 37a in an X axis direction, which is one horizontal direction in the manufacturing region R, and is reflected by the second galvano mirror 37b in an Y axis direction, which is another horizontal direction in the manufacturing region R and orthogonal to the X axis direction, to perform scanning, according to a coordinate system for manufacturing to be described below.

The laser beam B reflected by the first galvano mirror 37a and the second galvano mirror 37b is transmitted through the window 1a and irradiated on the material layer 85 in the manufacturing region R, whereby the solidified layer 86 is formed. The irradiation device 13 is not limited to the above-described form. For example, an fθ lens may be provided instead of the focus control unit 35. In addition, the irradiation device 13 may be configured to irradiate electron beams instead of the laser beam B to solidify the material layer 85. Specifically, the irradiation device 13 may be configured to include a cathode electrode that emits electrons, an anode electrode that causes the electrons to converge and be accelerated, a solenoid that forms a magnetic field and converges the directions of electron beams in one direction, a collector electrode that is electrically connected to the material layer 85, which is an article to be irradiated, and a high voltage power supply that applies voltage pulse between the cathode electrode and the collector electrode.

In addition to the above-described configuration, the additive manufacturing apparatus 100 may include a machining device (not shown) for carrying out machining such as cutting on the solidified layer 86 and manufactured products as necessary in the chamber 1. The machining device is configured by, for example, mounting a tool for carrying out machining such as cutting (for example, an end mill) on a working head and carries out machining on the solidified layer 86 or manufactured articles by appropriately moving the working head in the horizontal direction and the vertical direction. In addition, the tool may be configured so as to be rotatable by being mounted on a spindle in the working head.

2. Setting of Coordinate System for Manufacturing

In the additive manufacturing apparatus 100, a machine coordinate system for designating positions in the manufacturing region R is set in advance. The machine coordinate system is intrinsically set in the additive manufacturing apparatus 100 and does not change regardless of manufacturing conditions. In order to irradiate a desired position in the material layer 85 on the base plate 81 with the laser beam B using the irradiation device 13 or carry out machining on the solidified layer 86 or manufactured articles on the base plate 81, it is necessary to set a coordinate system for manufacturing based on the base plate 81, which is disposed in the manufacturing region R, prior to manufacturing. The coordinate system for manufacturing is set each time the base plate 81 is replaced or the disposition is changed, and action commands for the irradiation device 13 or the machining device are produced based on the coordinate system for manufacturing. In addition, it is also possible to set the coordinate system for manufacturing for each of the devices that configure the additive manufacturing apparatus 100 such as the irradiation device 13 or the machining device.

In the present embodiment, in order to set the coordinate system for manufacturing, the coordinate of a point that serves as a reference in setting the coordinate system for manufacturing (reference point) in the machine coordinate system is specified. Specifically, an image of the base plate 81 disposed in the manufacturing region R is acquired with an imaging device, and the coordinate of at least one point to be detected in the machine coordinate system is acquired by image analysis. The point to be detected in the disclosure refers to a point that is imaged with the imaging device and the position of which is detected by image analysis in order to specify the coordinate of the reference point in the machine coordinate system. The coordinate of the reference point is obtained from the coordinate of the point to be detected, and the coordinate system for manufacturing is set using, for example, the reference point as the origin. As the reference point of the coordinate system for manufacturing, for example, a corner or the center of the base plate 81 in a plan view can be selected. In addition, as the point to be detected, it is possible to appropriately set a point that can be detected by image analysis to specify the reference point. In a case where the reference point itself can be detected by image analysis, it is possible to regard the reference point as the point to be detected. In detecting the point to be detected by image analysis such as edge detection as described below, the point to be detected is preferably set on a side that configures the outer edge of the base plate 81 in a plan view and more preferably set to a corner of the base plate 81 in a plan view.

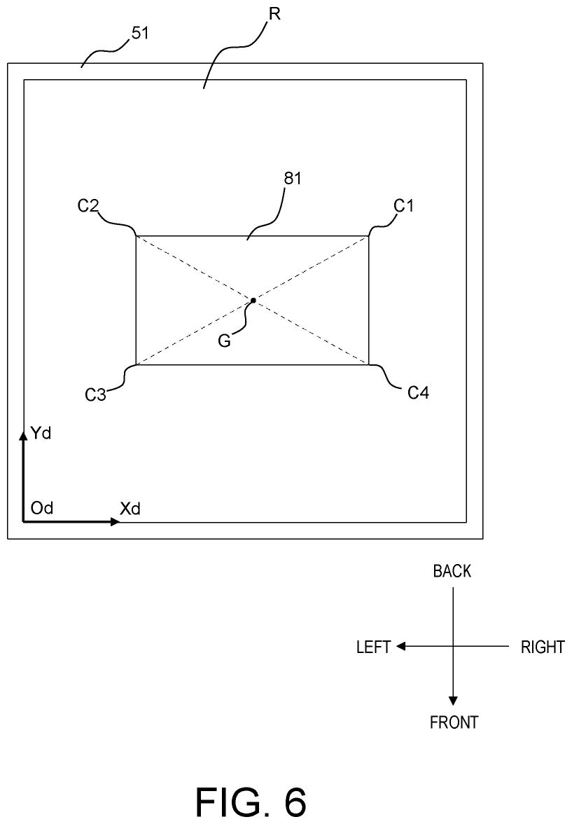

As an example, determination of the coordinate of the reference point in a case where the rectangular base plate 81 is disposed in the manufacturing region R as shown in FIG. 6 will be described. The downward, upward, left and right directions in FIG. 6 correspond to the front, back, left and right directions of the additive manufacturing apparatus 100, respectively. In the example of FIG. 6, the machine coordinate system is set such that the corner that is positioned at the intersection point of the front end and the left end of the manufacturing region R that is positioned inside a frame 51 in a plan view becomes an origin Od, the front end of the manufacturing region R becomes an Xd axis and the left end becomes an Yd axis. In a case where a corner C2 of the base plate 81 in a plan view is used as the reference point of the coordinate system for manufacturing, since the detection of the corner C2 by image analysis is relatively easy, it is possible to set the corner C2 as the point to be detected. The coordinate of the corner C2, which is the point to be detected, is acquired by image analysis, whereby the coordinate of the corner C2 as the reference point is specified.

As another example, it is also possible to use the center G of the base plate 81 in a plan view as the reference point of the coordinate system for manufacturing. In a case where it is difficult to directly detect the center G by image analysis, it is possible to set a point that is more easily detected as the point to be detected. For example, in a case where two corners C2 and C4 positioned at both ends of one diagonal line of the rectangular shape are set as the points to be detected, the coordinates of the corners C2 and C4 are acquired by image analysis, and the coordinate of the midpoint of a line segment connecting the corners C2 and C4 is obtained, whereby the coordinate of the center G, which is the reference point, can be specified. In addition, the coordinate of the center G may also be specified by carrying out the same working with, instead of the two corners C2 and C4, two corners C1 and C3 positioned at both ends of the other diagonal line of the rectangular shape regarded as the points to be detected. Alternatively, the coordinate of the center G may also be specified as the intersection point of the line segment connecting the corners C1 and C3 and the line segment connecting the corners C2 and C4 by regarding the four corners C1, C2, C3 and C4 as the points to be detected and acquiring the coordinates of these points by image analysis.

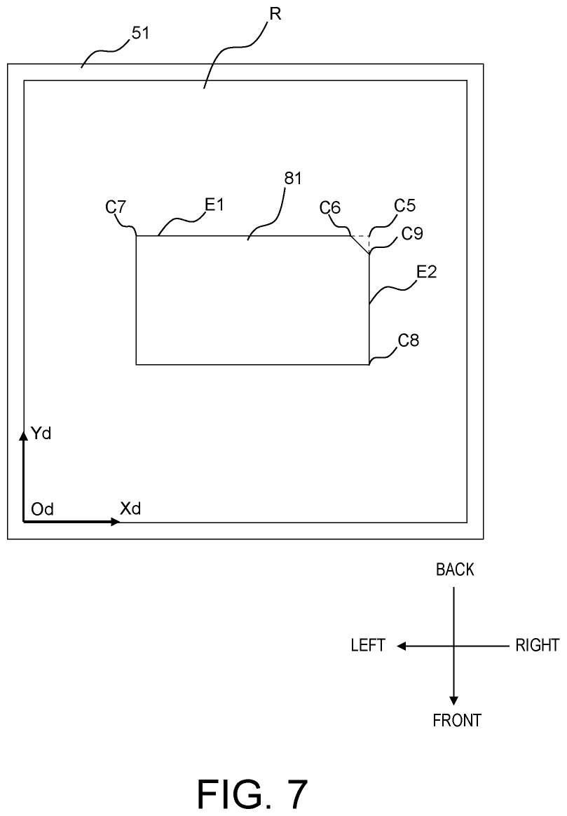

As still another example, determination of the coordinate of the reference point in a case where the base plate 81 in which one of the corners of the rectangular shape is chamfered is disposed in the manufacturing region R as shown in FIG. 7 will be described. In the example of FIG. 7, the machine coordinate system is set in the same manner as in FIG. 6. In a case where a point C5 that is the intersection point of the extended lines of two sides E1 and E2 of the base plate 81 that extend from the chamfered portion is regarded as the reference point of the coordinate system for manufacturing and a point to be detected, the coordinates of the sides E1 and E2 are obtained by image analysis. In addition, the coordinate of the intersection point of the extended lines of the sides E1 and E2 is obtained, whereby the coordinate of the point C5, which is the reference point and the point to be detected, can be specified.

3. Imaging Device

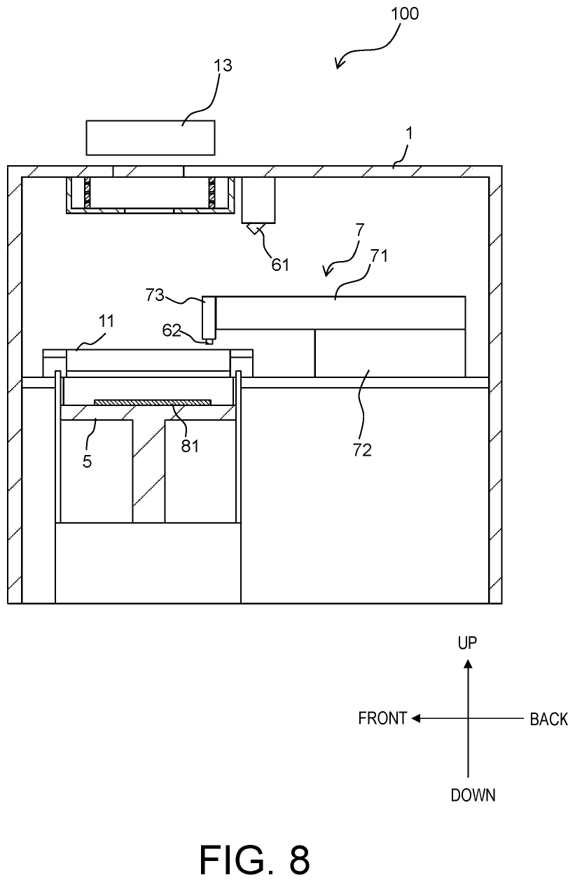

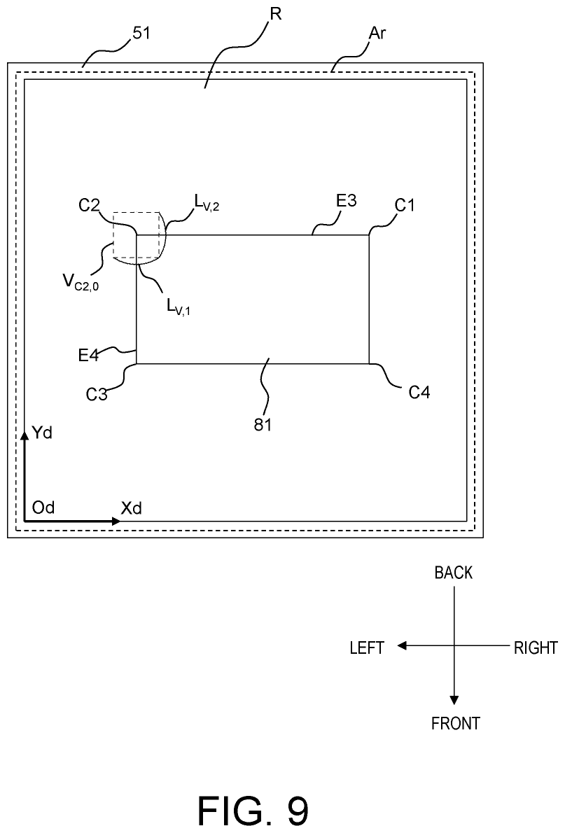

FIG. 8 is another schematic configuration view of the additive manufacturing apparatus 100 and is a view showing the configuration of the additive manufacturing apparatus 100 in FIG. 1 seen from the right side. The additive manufacturing apparatus 100 according to the present embodiment includes an imaging device for imaging the manufacturing region R from above. The imaging device is, for example, a CCD camera or a CMOS camera. The imaging device according to the present embodiment includes two cameras of an entire imaging camera 61 (an example of a second camera) and a partial imaging camera 62 (an example of a first camera), which are CCD cameras, as shown in FIG. 8, and each camera is controlled with an image processing device 43 to be described below to carry out imaging. FIG. 9 is a view showing an example of imaging regions or visual fields of the entire imaging camera 61 and the partial imaging camera 62 in the disposition of the base plate 81 in FIG. 6.

3.1. Entire Imaging Camera 61

The entire imaging camera 61 is provided in the chamber 1 and images an entire region Ar including all of the manufacturing region R to acquire an entire image. In order to include all of the manufacturing region R in the imaging region, the entire imaging camera 61 needs to be disposed above the manufacturing region R at a certain distance from the manufacturing region R. In the present embodiment, the entire imaging camera 61 is fixed to the ceiling part of the chamber 1. The entire image is analyzed with the image processing device 43, and the position information of the base plate 81 in the manufacturing region R is acquired.

3.2. Partial Imaging Camera 62

The partial imaging camera 62 is provided so as to be movable at least in the horizontal direction in the chamber 1 and is used to image a region that is a part of the entire region Ar and is in the vicinity of the point to be detected to acquire an image. The partial imaging camera 62 of the present embodiment can be horizontally moved with a camera moving device 7.

As shown in FIG. 8, the partial imaging camera 62 is mounted on one end of the camera moving device 7. The camera moving device 7 includes a first driving mechanism 71 that enables reciprocal movement in one horizontal direction in the manufacturing region R and a second driving mechanism 72 on which the first driving mechanism 71 is mounted and that enables reciprocal movement in a different horizontal direction orthogonal to the one horizontal direction and is controlled with a moving device control part 98 to be described below. The partial imaging camera 62 of the present embodiment is moved in the front and back direction of the additive manufacturing apparatus 100 with the first driving mechanism 71 and moved in the right and left direction of the additive manufacturing apparatus 100 with the second driving mechanism 72. This makes it possible to dispose the partial imaging camera 62 at an arbitrary position by freely moving the partial imaging camera 62 in the horizontal direction above the manufacturing region R. The camera moving device 7 may be configured so as to further move the partial imaging camera 62 in the vertical direction. The camera moving device 7 according to the present embodiment includes a third driving mechanism 73 that reciprocally moves the partial imaging camera 62 in the up and down direction. This makes it possible to appropriately adjust the distance from the manufacturing region R in the vertical direction. The first driving mechanism 71, the second driving mechanism 72 and the third driving mechanism 73 can be configured using, for example, a linear motor, a cylinder and a ball screw or a rack and pinion mechanism, respectively.

A control device 9 produces a move command for the partial imaging camera 62 using the position information of the base plate 81 and outputs the move command to the moving device control part 98. The moving device control part 98 operates the camera moving device 7 according to the move command and thereby moves the partial imaging camera 62 and disposes the partial imaging camera 62 at a predetermined position.

At the time of imaging, the partial imaging camera 62 is first disposed at an initial position in a vicinity immediately above the point to be detected. For example, in a case where the corner C2 in the disposition of the base plate 81 in FIG. 9 is regarded as the reference point and the point to be detected, the partial imaging camera 62 is disposed at an initial position at which the corner C2 and a part of a side E3 and a part of a side E4 of the base plate 81, which each reaches the corner C2 at one end point, are included in the visual field. Here, the sides E3 and E4 are sides that configure the outer edge of the base plate 81 in a plan view. In FIG. 9, it is possible to set the position of the partial imaging camera 62 at which the visual field becomes an initial region V_{c2, 0} as the initial position.

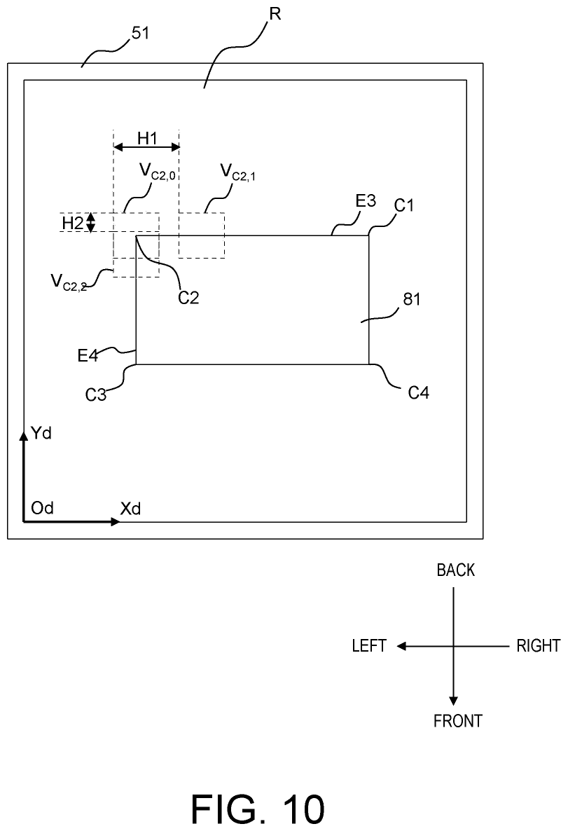

Next, the partial imaging camera 62 is moved by the camera moving device 7 toward the corner C1, which is the other end point of the side E3, from the initial position along the side E3. Specifically, as shown in FIG. 10, the partial imaging camera 62 is moved toward the corner C1 in a direction parallel to the side E3 by a distance H1 such that the visual field after the movement becomes a first region V_{c2, 1}. The first region V_{c2, 1} includes a part of the side E3. At the position after the movement, the partial imaging camera 62 images the first region V_{c2, 1} to acquire a first image.

Next, the partial imaging camera 62 is returned to the initial position by the camera moving device 7. This makes the visual field of the partial imaging camera 62 become the initial region V_{c2, 0}. In addition, the partial imaging camera 62 is moved by the camera moving device 7 toward the corner C3, which is the other end point of the side E4, from the initial position along the side E4. Specifically, as shown in FIG. 10, the partial imaging camera 62 is moved toward the corner C3 in a direction parallel to the side E4 by a distance H2 such that the visual field after the movement becomes a second region V_{c2, 2}. The second region V_{c2, 2} includes a part of the side E4. At the position after the movement, the partial imaging camera 62 images the second region V_{c2, 2} to acquire a second image.

As described above, the partial imaging camera 62 images the two sides (a first side and a second side) that configure the outer edge of the base plate in a plan view. The two sides are set for each point to be detected and are set such that the point to be detected becomes the intersection point of the two sides or the intersection point of the extended lines of the two sides. The partial imaging camera 62 is once disposed at the initial position set such that a part and one end point of the first side and a part and one end point of the second side are all included in the visual field, then, moved toward the other end point of each side along each side, images a first region including at least a part of the first side and a second region including at least a part of the second side at the positions after the movement and acquires the first image and the second image, respectively.

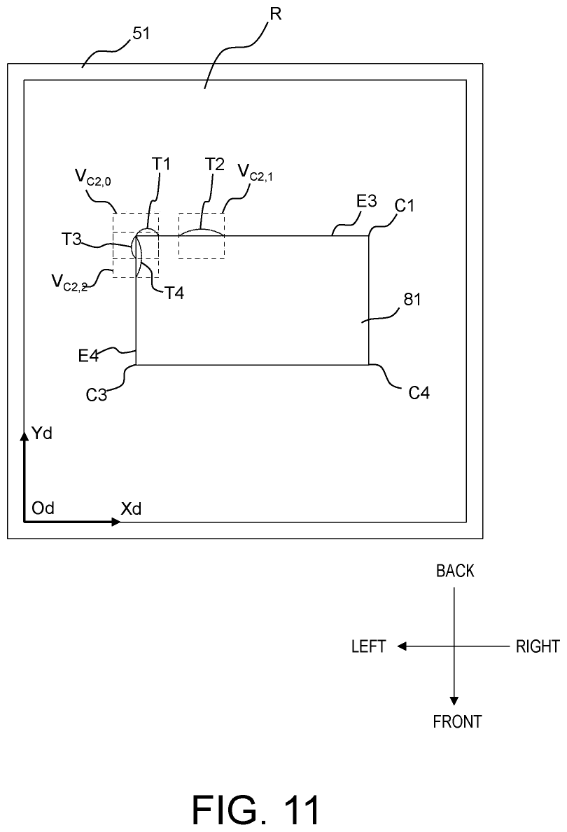

In a case where the partial imaging camera 62 is moved as described above, the length of the first side that is included in the first region and the length of the second side that is included in the second region become longer than the lengths of the first side and the second side that are included in the visual field at the initial position. As shown in FIG. 11, the length T2 of the side E3 that is included in the first region V_{c2, 1} is longer than the length T1 of the side E3 that is included in the initial region V_{c2, 0}. In addition, the length T4 of the side E4 that is included in the second region V_{c2, 2} is longer than the length T3 of the side E4 that is included in the initial region V_{c2, 0}.

As described below, image analysis such as edge detection is carried out on the first image and the second image, and the contour of the base plate 81, in other words, the outer edge of the base plate 81 in a plan view is detected. In a case where the position information of the sides that configure the outer edge is detected in such image analysis, as the lengths of the sides that are included in the images become longer, the detection accuracy becomes higher. Therefore, the position information of the first side and the second side that is obtained by analyzing the first image and the second image becomes highly accurate compared with that in a case where detection is carried out from the images imaged at the initial position. In addition, during the movement along each side, since the distance in the vertical direction between the partial imaging camera 62 and the base plate 81 is constant, it becomes possible to increase the information on the inside of the visual field without broadening the distance from an article to be detected.

In a case where the partial imaging camera 62 is moved along each side, the partial imaging camera 62 is preferably moved parallel to each side. This makes it possible to increase the lengths of the sides that are included in the visual field with the minimum amount of movement and enables efficient imaging.

The movement distance of the partial imaging camera 62 along each side is appropriately set depending on the shape or size of the base plate 81. The movement distance may be set such that the visual field after movement has no overlap with the visual field at the initial position like the relationship between the first region V_{c2, 1} and the initial region V_{c2, 0} shown in FIG. 10. In addition, the movement distance may be set such that the visual field after movement has an overlap with the visual field at the initial position like the relationship between the second region V_{c2, 2} and the initial region V_{c2, 0} shown in FIG. 10.

In addition, the movement distance may be set depending on the size of the visual field of the partial imaging camera 62. For example, the movement distances along the first side and the second side may be each set so as to be equal to half of the maximum length of the visual field of the partial imaging camera 62 in a direction parallel to the first side or the second side. In FIG. 9, the initial region V_{c2, 0}, which is the visual field of the partial imaging camera 62 at the initial position, has a length of L_{v, 1} in the direction parallel to the side E3 and a length of L_{v, 2} in the direction parallel to the side E4. In this case, the movement distance of the partial imaging camera along the side E3 may be set to L_{v, 1}/2, and the movement distance along the side E4 may be set to L_{v, 2}/2. In a case where the shape of the base plate 81 is relatively simple or the like, it becomes possible to shorten the time necessary for setting the movement distance while ensuring the detection accuracy to a certain extent by fixing the movement distance along each side as described above.

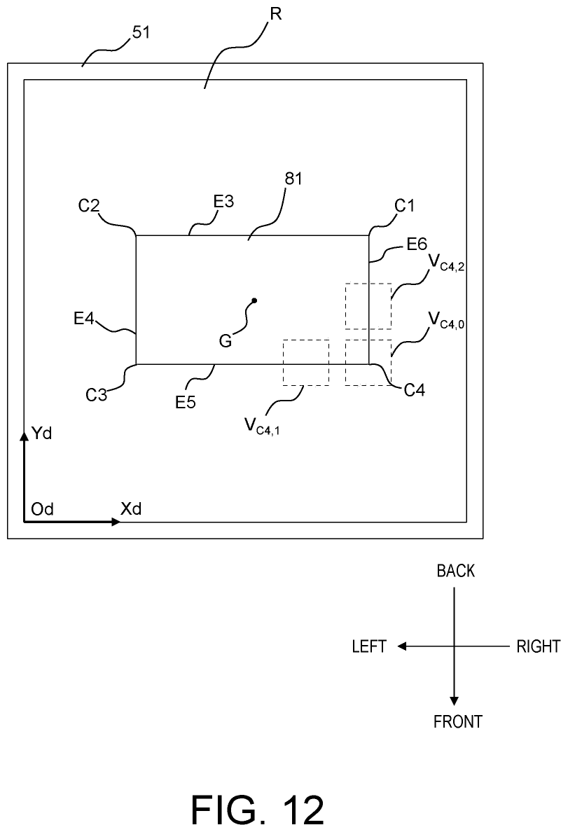

In a case where the center G in the disposition in FIG. 6 is used as the reference point and two corners C2 and C4 are regarded as points to be detected, the same working is carried out for each point to be detected. That is, for the corner C2, which is one point to be detected, the above-described working is carried out to acquire a first image and a second image. In addition, for the corner C4, which is the other point to be detected, a first image and a second image are acquired separately. Specifically, as shown in FIG. 12, the partial imaging camera 62 is disposed at an initial position at which the corner C4 and a part of a side E5 and a part of a side E6 of the base plate 81, which each reaches the corner C4 at one end point, are included in the visual field. Here, the sides E5 and E6 are sides that configure the outer edge of the base plate 81 in a plan view. In this case, it is possible to set the position of the partial imaging camera 62 at which the visual field becomes an initial region V_{c4, 0} as the initial position.

Next, the partial imaging camera 62 is moved toward the corner C3, which is the other end point of the side E5, from the initial position in a direction parallel to the side E5. The visual field after the movement becomes a first region V_{c4, 1}, and the first region V_{c4, 1} includes a part of the side E5. The partial imaging camera 62 images the first region V_{c4, 1} to acquire a first image.

Next, the partial imaging camera 62 is returned to the initial position by the camera moving device 7, and the visual field of the partial imaging camera 62 becomes the initial region V_{c4, 0} again. In addition, the partial imaging camera 62 is moved toward a corner C1, which is the other end point of the side E6, from the initial position in a direction parallel to the side E6. The visual field after the movement becomes a second region V_{c4, 2}, and the second region V_{c4, 2} includes a part of the side E6. The partial imaging camera 62 images the second region V_{c4, 2} to acquire a second image. In a case where a plurality of points to be detected are set as described above, the initial position is set for each point to be detected, and a first image and a second image are acquired.

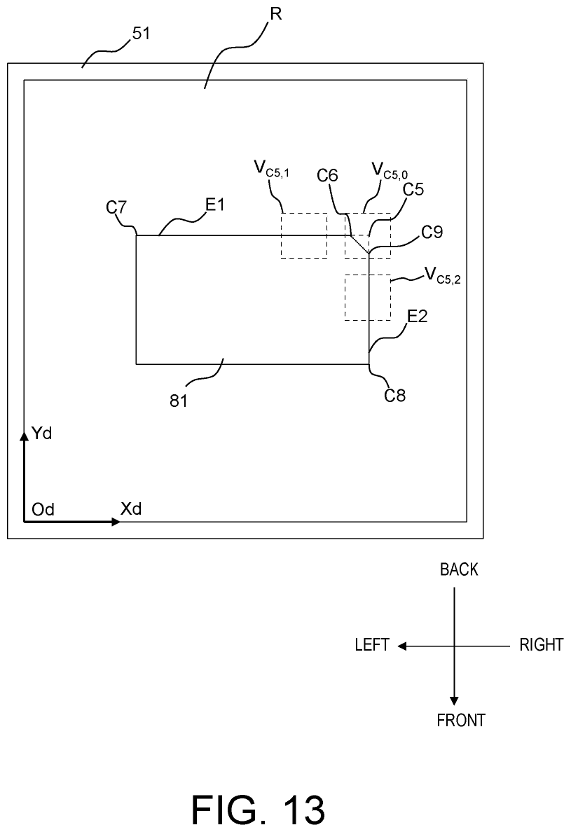

Imaging with the partial imaging camera 62 in the disposition of the base plate 81 shown in FIG. 7 will be described. In a case where a point C5 in such disposition is regarded as the reference point and a point to be detected, the partial imaging camera 62 is disposed at an initial position at which an end point C6 of a side E1 on the point C5 side, a part of the side E1 extending from the end point C6, an end point C9 of a side E2 on the point C5 side and a part of the side E2 extending from the end point C9 are included in the visual field. Here, the sides E1 and E2 are sides that configure the outer edge of the base plate 81 in a plan view. As shown in FIG. 13, it is possible to set the position of the partial imaging camera 62 at which the visual field becomes an initial region V_{c5, 0} as the initial position.

Next, the partial imaging camera 62 is moved toward a corner C7, which is the other end point of the side E1, from the initial position in a direction parallel to the side E1. The visual field after the movement becomes a first region V_{c5, 1}, and the first region V_{c5, 1} includes a part of the side E1. The partial imaging camera 62 images the first region V_{c5, 1} to acquire a first image.

Next, the partial imaging camera 62 is returned to the initial position by the camera moving device 7, and the visual field of the partial imaging camera 62 becomes the initial region V_{c5, 0} again. In addition, the partial imaging camera 62 is moved toward a corner C8, which is the other end point of the side E2, from the initial position in a direction parallel to the side E2. The visual field after the movement becomes a second region V_{c5, 2}, and the second region V_{c5, 2} includes a part of the side E2. The partial imaging camera 62 images the second region V_{c5, 2} to acquire a second image.

The configuration of the imaging device is not limited to the above-described configuration. For example, the imaging device may be configured to be provided with one camera, in which the camera has the functions of both the entire imaging camera 61 and the partial imaging camera 62. In this case, the camera is configured to be movable horizontally and movable vertically with the camera moving device 7.

4. Image Processing Device 43

The additive manufacturing apparatus 100 of the present embodiment includes the image processing device 43. The image processing device 43 is used to control the action of the imaging device and to process the entire image, the first image and the second image acquired by the imaging device.

The image processing device 43 may be realized with software or may be realized with hardware. In a case where the image processing device is realized with software, a variety of functions can be realized by causing CPU to execute computer programs. The programs may be stored in a built-in memory part or may be stored in a non-transitory computer readable recording medium. In addition, the image processing device may be realized by so-called cloud computing by reading programs stored in an external memory part. In the case of being realized with hardware, the image processing device can be realized with a variety of circuits such as an application specific integrated circuit (ASIC), a field programmable gate array (FPGA) and a dynamically reconfigurable processor (DRP).

4.1. Analysis of Entire Image

The image processing device 43 causes the entire imaging camera 61 to execute the imaging of the entire region Ar based on an action command from the control device 9 to be described below and analyzes the entire image to acquire the position information of the base plate 81 in the manufacturing region R. The position information of the base plate 81 in the disclosure refers to information necessary to specify the position of a point to be detected in the machine coordinate system.

Specifically, the image processing device 43, first, carries out filter processing on the entire image as preprocessing for facilitating the detection of the contour of the base plate 81. Edge detection is carried out on the entire image on which the filter processing has been carried out, and the contour of the base plate 81 is detected. In the filter processing and the edge detection, well-known method and algorithm can be applied.

The image processing device 43 acquires the positions of corners on the detected contour as the position information of the base plate 81. The image processing device 43 according to the present embodiment has a function of calibrating the intrinsic coordinate system, scaling and rotation of the entire imaging camera 61 fixed to the ceiling part. In the present embodiment, the positions of the corners specified in the intrinsic coordinate system of the entire imaging camera 61 are converted into the machine coordinate system using the calibration function, and the results are used as the position information of the base plate 81. The position information of the base plate 81 is not limited to the above-described example, and it is also possible to use, for example, the position and length of each side that configures the detected contour as the position information of the base plate 81. The position information of the base plate 81 obtained as described above is sent to the control device 9.

4.2. Analysis of First Image and Second Image

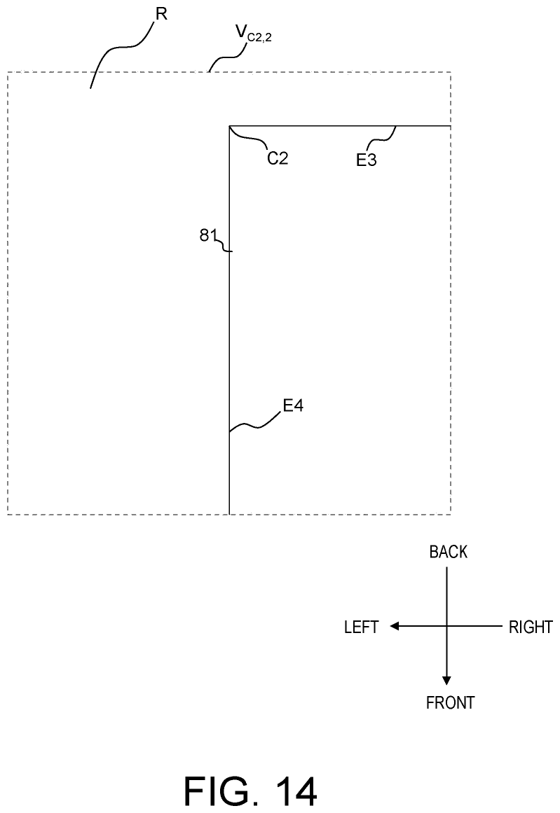

The image processing device 43 causes the partial imaging camera 62 to execute imaging based on an action command from the control device 9 and analyzes the first image and the second image to acquire the position information of the first side and the position information of the second side, respectively. Specifically, the image processing device 43, similar to the processing for the entire image, carries out filter processing and edge detection on the first image and the second image to detect the contour of the base plate 81. In the first image and the second image, the first side and the second side, which are the contour of the base plate 81, are included in a state of being enlarged compared with those in the entire image. For example, in a case where the second region V_{c2, 2} shown in FIG. 10 has been imaged, a second image as shown in FIG. 14 can be obtained.

The image processing device 43 acquires the position of the first side in the first image and the position of the second side in the second image as the position information of each side.

In the analysis of the second image in FIG. 14, the position of a side E4 in the second image is acquired. In the present embodiment, the positions of the first side and the second side specified in the intrinsic coordinate system of the partial imaging camera 62 are used as the position information of each side. The position information of the first side and the second side obtained as described above is sent to the control device 9.

5. Control Device 9

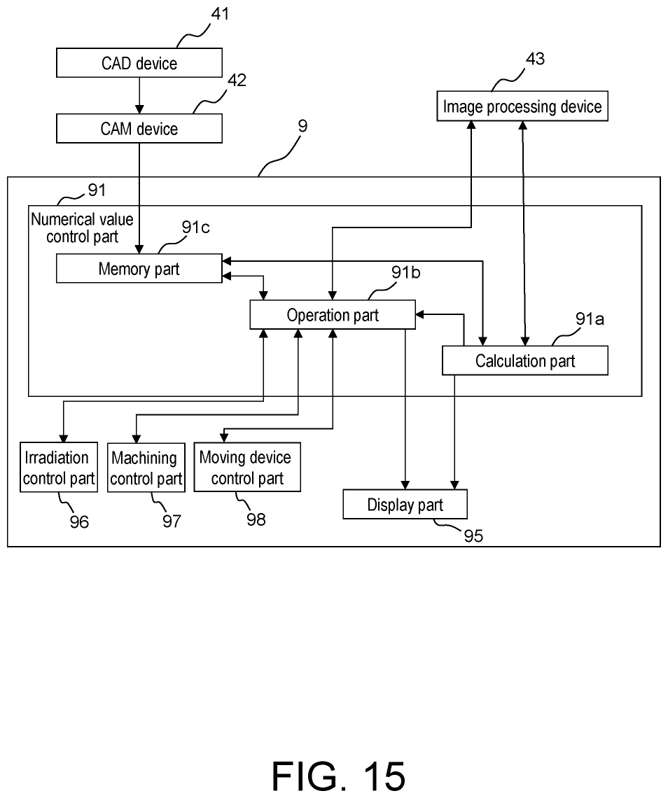

Next, the control device 9 for controlling the additive manufacturing apparatus 100 will be described. As shown in FIG. 15, the control device 9 includes a numerical value control part 91, a display part 95 and control parts 96, 97 and 98 for individual devices that configure the additive manufacturing apparatus 100.

“Part” in the control device 9 refers to, for example, a combination of hardware resources that are carried out by a circuit in a broad sense and the information processing of software that can be specifically realized by these hardware resources. In addition, in the present embodiment, diverse information is handled, this information is expressed by high and low signal values as a bit aggregate of binary numbers composed of 0 or 1, and communication and operation on a circuit in a broad sense can be executed. In addition, the circuit in a broad sense refers to a circuit that is realized by at least appropriately combining a circuit, circuitry, a processor, a memory and the like. That is, examples of the circuit include an application specific integrated circuit (ASIC), programmable logic devices (for example, a simple programmable logic device (SPLD), a complex programmable logic device (CLPD) and a field programmable gate array (FPGA)) and the like. Furthermore, such programs may be stored in a built-in memory part or may be stored in a non-transitory computer readable recording medium. In addition, the image processing device may be realized by so-called cloud computing by reading programs stored in an external memory part.

A CAD device 41 and a CAM device 42 are installed outside the control device 9. The CAD device 41 is a device for producing three-dimensional shape data (CAD data) showing the shape and dimensions of an additively manufactured article, which is an article to be manufactured. The produced CAD data is output to the CAM device 42.

The CAM device 42 is a device for producing the action order data (CAM data) of each device that configures the additive manufacturing apparatus 100 at the time of manufacturing the additively manufactured article based on the CAD data. In the CAM data, for example, the data of the irradiation position in each material layer 85 with the laser beam B and the data of the laser irradiation conditions with the laser beam B are included. The produced CAM data is output to the numerical value control part 91.

The numerical value control part 91 controls the image processing device 43, which is provided outside the control device 9, calculates the coordinate of a point to be detected using information that is sent from the image processing device 43, and carries out the specification of the reference point and the setting of the coordinate system for manufacturing. Furthermore, the numerical value control part 91 carries out an operation by a numerical value control program on the CAM data appropriately using the coordinate system for manufacturing and carries out an action command on the additive manufacturing apparatus 100.

The numerical value control part 91 includes a calculation part 91a, an operation part 91b and a memory part 91c. The operation part 91b outputs an action command for the acquisition and analysis of the entire image to the image processing device 43. In addition, the calculation part 91a calculates the coordinate of the point to be detected in the machine coordinate system from the position information of the base plate 81 sent from the image processing device 43 as a first calculated coordinate. In the present embodiment, the position of a corner is acquired in the image processing device 43 as described above, and the result converted into the machine coordinate system is sent to the control device 9 as the position information of the base plate 81. Therefore, in a case where a corner is set as the point to be detected, it is possible to use the coordinate of the point to be detected sent from the image processing device 43 as it is as the first calculated coordinate.

The first calculated coordinate is sent to the operation part 91b. The operation part 91b produces a move command for the partial imaging camera 62 using the position information of the base plate 81 and the first calculated coordinate and outputs the move command to the moving device control part 98 that controls the camera moving device 7. The moving device control part 98 controls the action of the camera moving device 7 based on the move command. Specifically, the moving device control part 98 operates the first driving mechanism 71, the second driving mechanism 72 and the third driving mechanism 73 according to the move command to move the partial imaging camera 62 in the horizontal direction and/or in the vertical direction. This makes the partial imaging camera 62 disposed at the initial position in a vicinity immediately above the point to be detected and then moves the partial imaging camera 62 along the first side and the second side to positions at which the first region and the second region can be imaged.

Furthermore, the calculation part 91a calculates the coordinate of the point to be detected in the machine coordinate system from the position information of the first side and the second side sent from the image processing device 43 as a second calculated coordinate. In the present embodiment, the positions of the first side and the second side specified in the intrinsic coordinate system of the partial imaging camera 62 are converted into the machine coordinate system by adding the positions of the partial imaging camera 62 at the time of imaging the first image and the second image. In addition, the coordinate of the intersection point of the first side and the second side or the intersection point on the extended lines of the first side and the second side as the point to be detected is calculated as the second calculated coordinate. Furthermore, the coordinate of the reference point in the machine coordinate system is specified from the second calculated coordinate, and the coordinate system for manufacturing is set using, for example, the reference point as the origin. The second calculated coordinate, the coordinate of the reference point and the information of the set coordinate system for manufacturing are sent to the operation part 91b. The operation part 91b carries out an operation by a numerical value control program on the CAM data appropriately using the coordinate system for manufacturing and outputs action commands to the control parts for individual devices that configure the additive manufacturing apparatus 100 in a form of the data of signals or action command values.

The memory part 91c memorizes the CAM data, the numerical value control programs, the position information of the base plate 81, the position information of the first side and the second side, the first and second calculated coordinates, the coordinate of the reference point, the information on the coordinate system for manufacturing and the like. The display part 95 displays the position information of the base plate 81, the position information of the first side and the second side, the action commands that are output by the operation part 91b in the numerical value control part 91 and the like.

An irradiation control part 96 controls the action of the irradiation device 13 based on an action command. Specifically, the irradiation control part 96 controls the light source 31 to output the laser beam B at predetermined laser power and irradiation timing. In addition, the irradiation control part 96 controls the motor of the focus control unit 35 to move a focus control lens, whereby the laser beam B is adjusted to a predetermined beam diameter. In addition, the irradiation control part 96 controls a first actuator and a second actuator to rotate the first galvano mirror 37a and the second galvano mirror 37b at desired angles, respectively, whereby a predetermined position in the material layer 85 on the base plate 81 is irradiated with the laser beam B. The action commands to the irradiation control part 96, in particular, the action commands relating to the control of actuators are produced based on the coordinate system for manufacturing.

A machining control part 97 controls the action of the machining device based on an action command. Specifically, the working head is moved up to a predetermined position. In addition, the tool is caused to act at a predetermined timing to carry out machining such as cutting. The action commands to the machining control part 97, in particular, the action commands relating to the movement of the working head are produced based on the coordinate system for manufacturing. The above-described individual control parts 96, 97 and 98 provide feedback on the actual action information of the individual devices to the numerical value control part 91.

6. Method for Producing Additively Manufactured Article

Next, a method for manufacturing an additively manufactured article using the additive manufacturing apparatus 100 according to the present embodiment will be described. The manufacturing method of the present embodiment includes a setting step of the coordinate system for manufacturing, a material layer formation step and a solidification step that are carried out after the setting step.

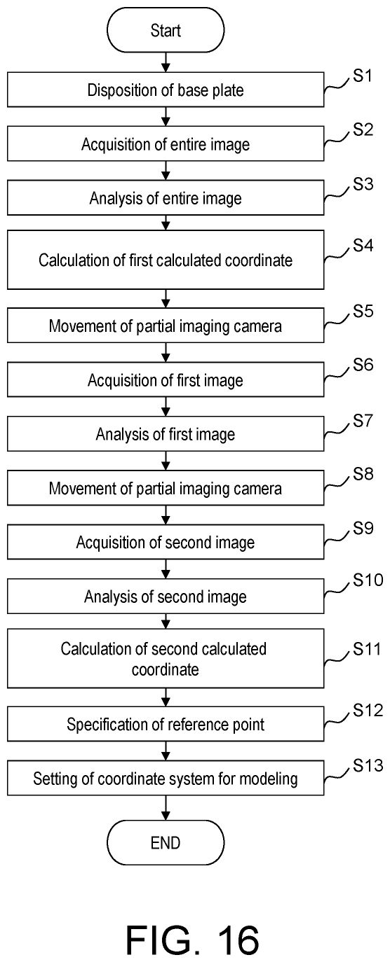

FIG. 16 is a flowchart showing the order of the setting step of the coordinate system for manufacturing that is carried out prior to additive manufacturing. First, the base plate 81 is disposed in the manufacturing region Ron the manufacturing table 5 (step S1).

First, the entire region Ar is imaged with the entire imaging camera 61, and an entire image is acquired (step S2). The entire image is sent to the image processing device 43, and the image processing device 43 analyzes the entire image to acquire the position information of the base plate 81 (step S3). The position information of the base plate 81 is sent to the calculation part 91a in the control device 9. The calculation part 91a calculates the coordinate of the point to be detected from the position information of the base plate 81 as the first calculated coordinate (step S4).

The position information of the base plate 81 and the first calculated coordinate are sent to the operation part 91b, and the operation part 91b produces a move command for the partial imaging camera 62. Based on the move command, the camera moving device 7 disposes the partial imaging camera 62 at an initial position and then moves the partial imaging camera 62 along the first side by a predetermined distance (step S5). The first region is imaged at a position after the movement, and a first image is acquired (first image acquisition step, step S6). The first image is sent to the image processing device 43, and the image processing device 43 analyzes the first image to acquire the position information of the first side (first image analysis step, step S7). The position information of the first side is sent to the calculation part 91a in the control device 9.

Next, the camera moving device 7 returns the partial imaging camera 62 to the initial position and then moves the partial imaging camera 62 along the second side by a predetermined distance (step S8). The second region is imaged at a position after the movement, and a second image is acquired (second image acquisition step, step S9). The second image is sent to the image processing device 43, and the image processing device 43 analyzes the second image to acquire the position information of the second side (second image analysis step, step S10). The position information of the second side is sent to the calculation part 91a in the control device 9.

The calculation part 91a converts the position information of the first side and the second side into the machine coordinate system and calculates the coordinate of the point to be detected as the second calculated coordinate (calculation step, step S11). Furthermore, the coordinate of the reference point is specified from the second calculated coordinate (step S12), and the coordinate system for manufacturing is set using the reference point as a reference (step S13).

In FIG. 16, for the convenience of description, an order in which the acquisition and analysis of the first image (steps S6 and S7) are carried out and then the acquisition and analysis of the second image (steps S9 and S10) are carried out has been shown, but the order of the steps relating to image acquisition and analysis is not limited thereto. The first image and the second image may be analyzed after the first image and the second image are acquired.

After the coordinate system for manufacturing is set in the above-described order, the material layer formation step and the solidification step are carried out. In the material layer formation step, a material powder is supplied to the upper surface of the base plate 81 disposed in the manufacturing region R to form the material layer 85. In the solidification step, a predetermined irradiation region in the material layer 85 is irradiated with the laser beam B or an electron beam to form the solidified layer 86. The material layer formation step and the solidification step are carried out repeatedly.

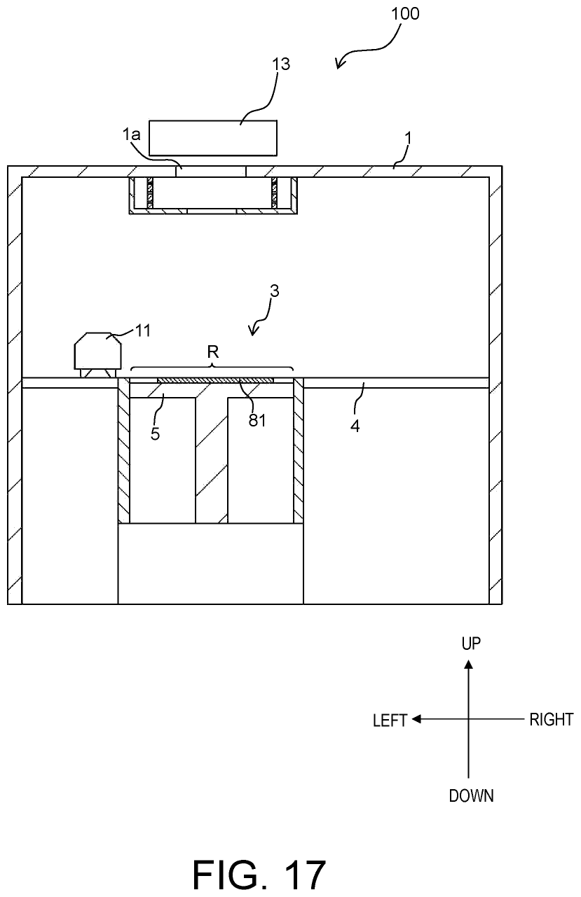

First, a first material layer formation step is carried out. As shown in FIG. 17, the height of the manufacturing table 5 is adjusted to an appropriate position in a state where the base plate 81 is placed on the manufacturing table 5. In this state, the recorder head 11 is moved from the left side toward the right side in FIG. 17, whereby a first material layer 85 is formed on the base plate 81.

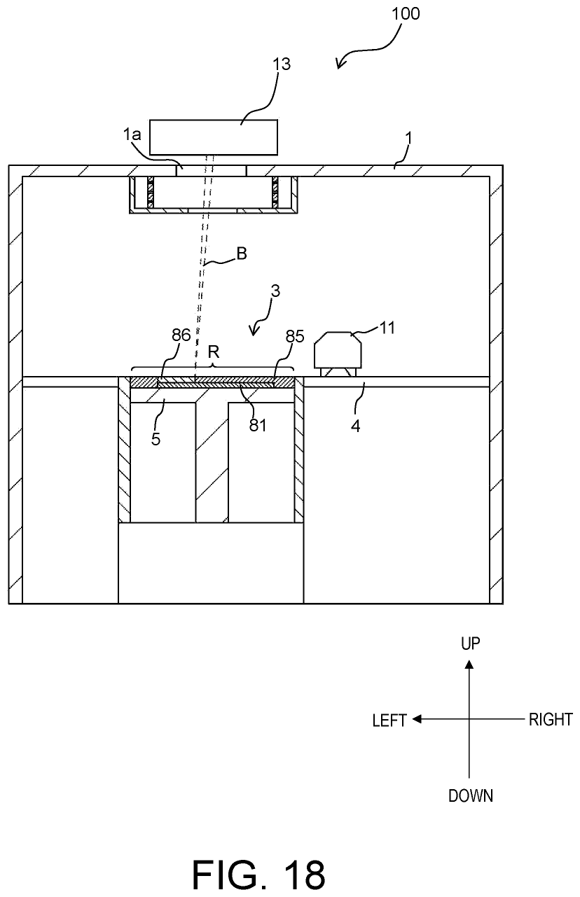

Next, a first solidification step is carried out. As shown in FIG. 18, a predetermined irradiation region in the first material layer 85 is irradiated with the laser beam B or an electron beam, whereby the first material layer 85 is solidified and a first solidified layer 86 is obtained.

Subsequently, a second material layer formation step is carried out. After the formation of the first solidified layer 86, the height of the manufacturing table 5 is lowered by the thickness of one material layer 85. In this state, the recorder head 11 is moved from the right side toward the left side of the manufacturing region R in FIG. 18, whereby a second material layer 85 is formed so as to cover the first solidified layer 86. In addition, a second solidification step is carried out. A predetermined irradiation region in the second material layer 85 is irradiated with the laser beam B or an electron beam by the same method as described above, whereby the second material layer 85 is solidified and a second solidified layer 86 is obtained.

The material layer formation step and the solidification step are repeated until a desired three-dimensional manufactured article can be obtained, and a plurality of solidified layers 86 are laminated. Adjacent solidified layers 86 are firmly fixed to each other. In addition, during manufacturing or after manufacturing, cutting or the like with the machining device is carried out as necessary. After the completion of the additive manufacturing, the unsolidified material powder and cutting chips are discharged, whereby an additively manufactured article can be obtained.

7. Other Embodiments

Hitherto, a preferable embodiment of the disclosure has been described, but the disclosure is not limited to the above-described embodiment and allows a variety of design changes within the scope of the claims. For example, the disclosure can be carried out in the following aspects.

7.1. Second Embodiment

In the first embodiment, the first side and the second side are each imaged once using the partial imaging camera 62, and one first image and one second image are acquired. In an additive manufacturing apparatus 100 and a method for manufacturing an additively manufactured article according to a second embodiment, imaging is carried out a plurality of times at changed movement distances from the initial position along individual sides, and a plurality of first images and a plurality of second images are acquired. Hereinafter, regarding the second embodiment, differences from the first embodiment will be mainly described.

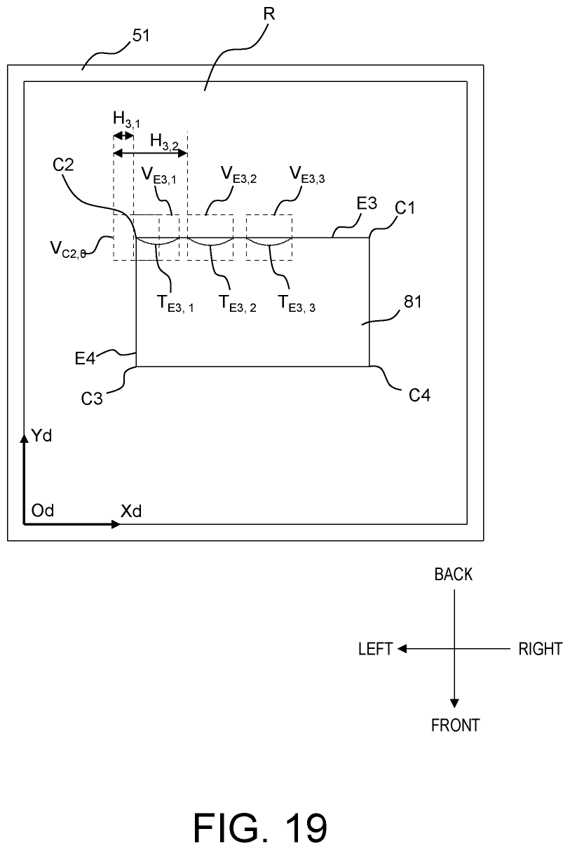

Regarding the acquisition of the first images and the second images in the second embodiment, a case where a corner C2 in the disposition of the base plate 81 in FIG. 19 is regarded as the reference point and a point to be detected will be described as an example. First, the partial imaging camera 62 is, similar to the first embodiment, disposed at an initial position at which the corner C2 and a part of a side E3 and a part of a side E4 of the base plate 81, which each reaches the corner C2 at one end point, are included in the visual field. The visual field at the initial position becomes an initial region V_{c2, 0} shown in FIG. 19. Next, the partial imaging camera 62 is moved toward a corner C1 in a direction parallel to the side E3 by a distance H_{3, 1}, whereby the visual field after the movement becomes a first region V_{E3, 1}. The first region V_{E3, 1} is imaged at this position, and a first image is acquired.

Next, the partial imaging camera 62 is returned to the initial position, whereby the visual field of the partial imaging camera 62 becomes a region V_{c2, 0} again. In addition, the partial imaging camera 62 is moved toward the corner C1 in a direction parallel to the side E3 from the initial position by a distance H_{3, 2} that is different from the movement distance H_{3, 1} at the time of the first imaging, whereby the visual field after the movement becomes a first region V_{E3, 2}. The first region V_{E3, 2} is imaged at this position, and a second first image is acquired.

The above-described working is repeated while the movement distance is changed, whereby a plurality of first regions V_{E3, 1}, V_{E3, 2} and V_{E3, 3} are imaged, and a plurality of first images is acquired. The movement distances are set so that the first regions during individual imaging include at least a part of the side E3. The first regions during individual imaging may have an overlap with each other or may have no overlap.

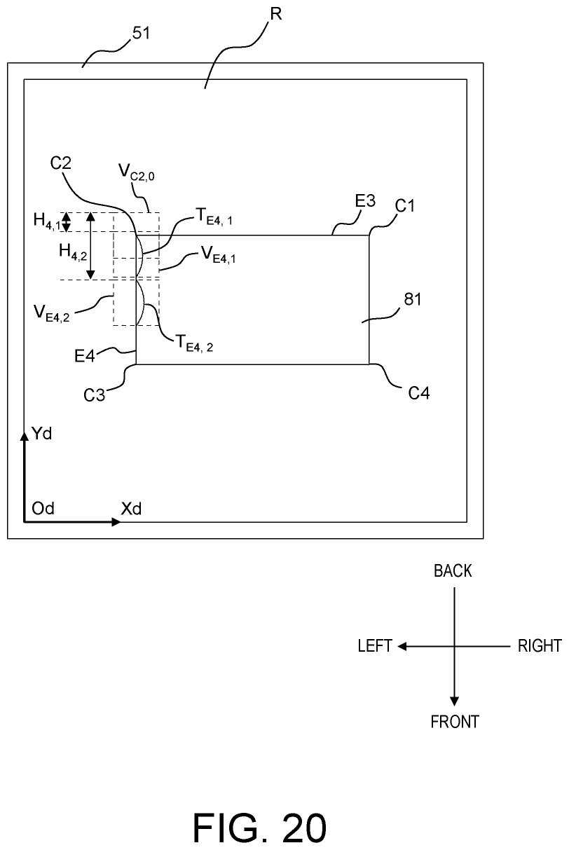

The same working is carried out, and a plurality of second images are acquired. As shown in FIG. 20, the partial imaging camera 62 is moved toward a corner C3 in a direction parallel to the side E4 from the initial position by a distance H_{4, 1}, a second region V_{E4, 1} is imaged at this position, and a first second image is acquired. The partial imaging camera 62 is returned to the initial position and then moved toward the corner C3 in the direction parallel to the side E4 by a distance H_{4, 2} that is different from the movement distance H_{4, 1}, a second region V_{E4, 2} is imaged at this position, and a second image is acquired. Such working is repeated while the movement distance is changed, whereby a plurality of second images are acquired.

The image processing device 43 analyzes each of the plurality of first images to acquire the position information of the first side and analyzes each of the plurality of second images to acquire the position information of the second side. That is, for each of the first side and the second side, a plurality of position information is obtained from different images. In the example of FIG. 19 and FIG. 20, similar to the first embodiment, the positions of the sides E3 and E4 that are included each image are specified in the intrinsic coordinate system of the partial imaging camera 62. Furthermore, the image processing device 43 detects the lengths of the first sides that are included in the first images and the lengths of the second sides that are included in the second images. In FIG. 19, the lengths T_{E3, 1}, T_{E3, 2} and T_{E3, 3} of the sides E3 that are included in the individual first images are detected from the first images obtained by imaging the first regions V_{E3, 1}, V_{E3, 2} and V_{E3, 3}, respectively. In addition, in FIG. 20, the lengths T_{E4, 1} and T_{E4, 2} of the sides E4 that are included in the individual second images are detected from the second images obtained by imaging the second regions V_{E4, 1} and V_{E4, 2}, respectively. The position information of the first side and the second side obtained as described above and the detection results of the lengths of the individual sides are sent to the control device 9.

The calculation part 91a in the control device 9 selects, among the plurality of position information of the first side, the position information of the first side acquired form the first image where the detected length of the side E3 is the longest. In addition, the calculation part 91a selects, among the plurality of position information of the second side, the position information of the second side acquired form the second image where the detected length of the side E4 is the longest. In addition, the selected position information of the first side and the second side is converted into the machine coordinate system, and the coordinate of the corner C2, which is the point to be detected, in the machine coordinate system is calculated as the second calculated coordinate.

When the movement distance along each side is changed, and a plurality of images are acquired and analyzed as described above, it becomes possible to select the position information of the side acquired from an image where the length of the side to be detected is longer. As the length of the side that is included in an image becomes longer, the detection accuracy becomes higher, and thus the accuracy of the coordinate of a reference point can be improved by using the position information of the side acquired from the image where the length of the side to be detected is the longest in the calculation of the coordinate of a point to be detected.

7.2. Third Embodiment

In an additive manufacturing apparatus 100 and a method for manufacturing an additively manufactured article according to a third embodiment, a plurality of first images and a plurality of second images are acquired and analyzed in the same manner as in the second embodiment, but the using form of a plurality of position information of a first side and a second side that is obtained by the analysis is different. Hereinafter, regarding the third embodiment, differences from the second embodiment will be mainly described.

Similar to the second embodiment, a plurality of position information of a first side and a second side obtained by analysis in the image processing device 43 is sent to the control device 9. The calculation part 91a in the control device 9 carries out statistical processing on the plurality of position information and calculates the coordinate of a point to be detected in the machine coordinate system using the result as the second calculated coordinate.

For example, the coordinate of the first side is calculated from each of the plurality of position information of the first side, and the arithmetic average of the obtained coordinates is obtained. The same processing is carried out on the plurality of position information of the second side, and the second calculated coordinate is calculated using the averaged coordinates of the first side and the second side.

In addition, as preprocessing of such statistical processing, at least one position information that is considered to be inappropriate for the use in the calculation of the point to be detected may be removed in advance. For example, in the first imaging of each side, ordinarily, a working miss is likely to be caused during the movement of the partial imaging camera 62, and thus the position information obtained from the first image and the second image acquired in the first imaging of each side may be removed. Alternatively, among the plurality of position information of each side, the position information acquired from an image where the detected length of the side is shorter than a predetermined threshold value may be removed in advance for the reason of a relatively low detection accuracy.

7.3. Other Modification Examples

In the first embodiment, the position information of the base plate 81 is acquired by the analysis of the entire image acquired with the entire imaging camera 61, and the disposition at the initial position and the subsequent movement along each side of the partial imaging camera 62 are carried out according to move commands produced using the position information, but a different configuration is also conceivable. For example, a worker may input information for specifying the position of a point to be detected such as the size or disposition of the base plate 81 to the control device 9 as the position information of the base plate 81, and the control device 9 may produce move commands for the partial imaging camera 62 using the position information. Such a semi-automatic configuration can be selected in a case where the acquisition of the position information of the base plate 81 by the analysis of the entire image is difficult due to a condition such as the color or surface quality of the base plate 81 or a case where the size or disposition of the base plate 81 (for example, the distance of the base plate 81 from the frame 51) is already known.

In addition, the additive manufacturing apparatus may be configured by providing a working part for working the camera moving device 7 and allowing a worker to input information to the working part to work the camera moving device 7. In this case, it is necessary for the worker to manually work the camera moving device 7 to carry out the disposition at the initial position and the subsequent movement along each side of the partial imaging camera 62. Such a manual configuration can be selected in a case where the acquisition of the position information of the base plate 81 by the analysis of the entire image is difficult due to a reason that the base plate 81 has a particularly complex shape or additive manufacturing is carried out after a different processing method is carried out in hybrid manufacturing and the position information of the base plate 81 is also not clear.

Furthermore, the additive manufacturing apparatus 100 may be configured so as to be capable of switching the operation mode according to the configuration of the above-described embodiment, the semi-automatic configuration and the manual configuration based on the control by the control device 9. In this case, the control device 9 may be provided with a mode switching part that switches the operation mode.

Hitherto, a variety of embodiments according to the disclosure have been described, but these are proposed as examples and do not intend to limit the scope of the disclosure. The novel embodiments can be carried out in a variety of other forms and can be omitted, substituted, or changed in a variety of manners within the scope of the gist of the disclosure. The embodiments or modifications thereof are included in the scope or gist of the disclosure and are included in inventions described in the claims and the equivalent scope thereof.

What is claimed is:

1. An additive manufacturing apparatus comprising:
a chamber;
a manufacturing table;
a material layer formation device;
an irradiation device;
an imaging device;
an image processing device; and
a control device,
wherein a manufacturing region is provided on the manufacturing table,
the chamber covers the manufacturing region,
a base plate is disposed in the manufacturing region,
the base plate includes a first side and a second side that configure an outer edge of the base plate in a plan view,
the material layer formation device forms a material layer on an upper surface of the base plate by supply of a material powder,
the irradiation device forms a solidified layer by irradiating the material layer with a laser beam or an electron beam,
the imaging device includes a first camera provided so as to be movable in the chamber,
the first camera images a first region including at least a part of the first side to acquire a first image at a position moved along the first side toward the other end point of the first side from an initial position set such that a part and one end point of the first side and a part and one end point of the second side are included in a visual field of the first camera and images a second region including at least a part of the second side to acquire a second image at a position moved along the second side toward the other end point of the second side from the initial position,
the image processing device analyzes the first image to acquire position information of the first side and analyzes the second image to acquire position information of the second side, and
the control device calculates a coordinate of an intersection point of the first side and the second side or an intersection point on extended lines of the first side and the second side as a point to be detected using the position information of the first side and the position information of the second side.

2. The additive manufacturing apparatus according to claim 1,
wherein the first camera images the first region at changed movement distances from the initial position to acquire a plurality of first images and images the second region at changed movement distances from the initial position to acquire a plurality of second images, and
the image processing device analyzes each of the plurality of first images to acquire the position information of the first side and analyzes each of the plurality of second images to acquire the position information of the second side.

3. The additive manufacturing apparatus according to claim 2,
wherein the image processing device detects lengths of the first sides that are included in the plurality of first images and detects lengths of the second sides that are included in the plurality of second images, and
the control device calculates the coordinate of the point to be detected using the position information of the first side acquired from the first image where the detected length of the first side is the largest and the position information of the second side acquired from the second image where the detected length of the second side is the largest.

4. The additive manufacturing apparatus according to claim 2,
wherein the control device calculates the coordinate of the point to be detected using a statistical processing result of the position information of the first side and the position information of the second side.

5. The additive manufacturing apparatus according to claim 1,
wherein the first camera images the first region at a position moved parallel to the first side by a predetermined distance from the initial position to acquire a first image,
the predetermined distance is equal to half of a maximum length of the visual field in a direction parallel to the first side,
the first camera images the second region at a position moved parallel to the second side by a predetermined distance from the initial position to acquire a second image, and
the predetermined distance is equal to half of a maximum length of the visual field in a direction parallel to the second side.

6. The additive manufacturing apparatus according to claim 1, further comprising:
a camera moving device,
wherein the imaging device includes a second camera fixed in the chamber,
the second camera images a region including all of the manufacturing region to acquire an entire image,
the image processing device analyzes the entire image to acquire position information of the base plate in the manufacturing region,
the control device produces a move command of the first camera using the position information of the base plate, and
the camera moving device moves the first camera according to the move command.

7. An additive manufacturing method, comprising:
a material layer formation step;
a solidification step;
first and second image acquisition steps;
first and second image analysis steps; and
a calculation step,
wherein, in the material layer formation step, in a chamber that covers a manufacturing region provided on a manufacturing table, a material powder is supplied to an upper surface of a base plate disposed in the manufacturing region to form a material layer,
in the solidification step, the material layer is irradiated with a laser beam or an electron beam to form a solidified layer,
the base plate includes a first side and a second side that configure an outer edge of the base plate in a plan view,
in the first image acquisition step, using a camera provided so as to be movable in the chamber, a first region including at least a part of the first side is imaged to acquire a first image at a position moved along the first side toward the other end point of the first side from an initial position set such that a part and one end point of the first side and a part and one end point of the second side are included in a visual field of the first camera,
in the second image acquisition step, using the camera, a second region including at least a part of the second side is imaged to acquire a second image at a position moved along the second side toward the other end point of the second side from the initial position,
in the first image analysis step, the first image is analyzed to acquire position information of the first side,
in the second image analysis step, the second image is analyzed to acquire position information of the second side, and
in the calculation step, a coordinate of an intersection point of the first side and the second side or an intersection point on extended lines of the first side and the second side is calculated as a point to be detected using the position information of the first side and the position information of the second side.
